(19) United States
(12) Patent Application Publication
(10) Pub. No.: US 2004/0054109 A1
(43) Pub. Date: Mar. 18, 2004

(54) Method for improving the process processability of butyl polymers

(76) Inventor: Gabor Kaszas, London (CA)

Correspondence Address: BAYER POLYMERS LLC, 100 BAYER ROAD, PITTSBURGH, PA, 15205, US

(21) Appl. No.: 10/602,935

(22) Filed: Jun. 24, 2003

(30) Foreign Application Priority Data
Jun. 28, 2002 (CA) 2,390,046

(51) Int. Cl. C08F 2/00

(52) U.S. Cl. 526/326

(57) ABSTRACT

The present invention relates to a method for improving the processability of butyl polymers by increasing the amount of repeating units derived from at least one multiolefin monomer in the polymer chain to more that 2.0 mol %. In particular, the present invention relates to a method of reducing the cold flow by increasing the amount of repeating units derived from at least one multiolefin monomer in the polymer chain to more that 2.0 mol %.

### FIELD OF THE INVENTION

The present invention relates to a method for improving the processability of butyl polymers by increasing the amount of repeating units derived from at least one multiolefin monomer in the polymer chain by 1.0 mol % over the typical value. The present invention also relates to a method of reducing the cold flow by increasing the amount of repeating units derived from at least one multiolefin monomer in the polymer chain by 1.0 mol % over the typical value.

### BACKGROUND OF THE INVENTION

Butyl rubber is known for its excellent gas barrier and dampening properties. Butyl rubber is a copolymer of an isoolefin and one or more multiolefins as comonomers. Commercial butyl contains a major portion of isoolefin and a minor amount of a multiolefin. The preferred isoolefin is isobutylene. Suitable multiolefins include isoprene, butadiene, dimethyl butadiene, piperylene, etc. of which isoprene is preferred. Halogenated butyl rubber is butyl rubber which has Cl and/or Br-groups.

Typical isoprene content of commercial butyl grades is around 1.6-1.8 mol %. This level of isoprene provides a good balance between cure rate and oxidative stability. In some specialty grades, isoprene content is increased in order to increase the rate and the state of cure. Typical isoprene content of these grades is around 2.2 mol %. In other specialty grades isoprene content is reduced to achieve enhanced oxidative, thermal and ozone resistance. In these grades the typical isoprene content is around 0.7 mol %.

Butyl rubber is halogenated in order to increase its cure rate. Most commonly used halogenating agents are elementary chlorine or bromine. Halogenation proceeds by the reaction of the halogenating agent with the isoprene units already present in the butyl chain. The result of the reaction is a halogen containing allylic structure. During the halogenation reaction only part of the isoprene is converted to the halogen containing allylic structure. Part of the isoprene remains unreacted. The unreacted isoprene units have only small effect on the cure rate due to the significantly higher cure reactivity of the halogenated isoprene units. Cure rate of halobutyl is altered by changing the halogen content and not by the changing the isoprene content.

Typical isoprene content of the butyl rubber used for the manufacturing of bromobutyl rubber is around 1.6-1.8 mol % before bromination. Approximately 0.9-1.2 mol % of these units are converted to the allylic and other minor brominated structures. Typical unreacted (residual) isoprene content of the commercially available bromobutyl grades is around 0.4-0.6 mol %.

Typical isoprene content of the butyl rubber used for the manufacturing of chlorobutyl rubber is around 2.0-2.2 mol % before chlorination. Approximately 1.5-1.7 mol % of these units are converted to the allylic and other minor chlorinated structures. Typical unreacted (residual) isoprene content of the commercially available chlorobutyl grades is around 0.4-0.6 mol %.

Generally, commercial butyl polymer is prepared in a low temperature cationic polymerization process using Lewis acid-type catalysts, of which a typical example is aluminum trichloride. The process used most extensively employs methyl chloride as the diluent for the reaction mixture and the polymerization is conducted at temperatures on the order of less than −90° C., resulting in production of a polymer in a slurry of the diluent. Alternatively, it is possible to produce the polymer in a diluent which acts as a solvent for the polymer (e.g., hydrocarbons such as pentane, hexane, heptane and the like). The product polymer may be recovered using conventional techniques in the rubber manufacturing industry.

While said commercial butyl polymers exhibit excellent properties in many applications, they have a tendency to flow during storage and transportation. This slow deformation/flow of the raw polymer or the uncured compound is also referred to as cold flow. Cold flow is more pronounced in grades of lower molecular weight or Mooney viscosity.

Switching to higher molecular weight/Mooney viscosity products can reduce cold flow. However, with increasing molecular weight the elasticity of the polymer and thereby its compound will increase resulting in increased die swell, mill shrinkage and reduced dimensional stability. Therefore it is highly desirable to reduce cold flow without effecting other processing properties of the polymer or its compound. In the present invention, it has been found that by increasing the isoprene content of a low viscosity (Mooney) butyl or halobutyl grade by about 1.0 mol % results in reduced cold flow without having any negative effect on other processing characteristics.

Processability-improving polymers are often added to butyl rubber to overcome some of these problems. Such polymers are particularly useful for improving the mixing or kneading property of a rubber composition. They include natural rubbers, synthetic rubbers (for example, IR, BR, SBR, CR, NBR, IIR, EPM, EPDM, acrylic rubber, EVA, urethane rubber, silicone rubber, and fluororubber) and thermoplastic elastomers (for example, of styrene, olefin, vinyl chloride, ester, amide, and urethane series). These processability-improving polymers may be used in the amount of up to 100 parts by weight, preferably up to 50 parts by weight, and most preferably up to 30 parts by weight, per 100 parts by weight of a butyl rubber. However, the presence of other rubbers dilutes said desirable properties of butyl rubber.

Co-Pending EP-A1-818 476 discloses a vanadium initiator system at relatively low temperatures and in the presence of an isoprene concentration which is slightly higher than conventional (approx. 2 mol % in the feed), but, as with AlCl₃-catalyzed copolymerization at −120° C., in the presence of isoprene concentrations of >2.5 mol % this results in gelation even at temperatures of −70° C. However, the above application is silent about improving cold-flow and processability.

### SUMMARY OF THE INVENTION

The present invention provides a method for improving the processability of polymers containing repeating units derived from at least one C₄ to C₇ isomonoolefin monomer, at least one C₄ to C₁₄ multiolefin monomer and optionally further monomers by increasing the amount of repeating units derived from said multiolefin monomer(s) in the polymer chain preferably to more than 2.0 mol %, more preferably to more than 2.5 mol %.

The present invention also provides a method for decreasing the cold flow of polymers containing repeating units derived from at least one C₄ to C₇ isomonoolefin monomer, at least one C₄ to C₁₄ multiolefin monomer and optionally further monomers by increasing the amount of repeating units derived from said multiolefin monomer(s) in the polymer chain preferably to more than 2.0 mol %, more preferably to more than 2.5 mol %.

The present invention further provides a method for improving the processability of halogenated polymers containing repeating units derived from at least one C₄ to C₇ isomonoolefin monomer, at least one C₄ to C₁₄ multiolefin monomer and optionally further monomers by increasing the amount of repeating units derived from said multiolefin monomer(s) in the polymer chain preferably to more than 2.0 mol %, more preferably to more than 2.5 mol %.

In addition, the present invention provides a method for decreasing the cold flow of halogenated polymers containing repeating units derived from at least one C₄ to C₇ isomonoolefin monomer, at least one C₄ to C₁₄ multiolefin monomer and optionally further monomers by increasing the amount of repeating units derived from said multiolefin monomer(s) in the polymer chain preferably to more than 2.0 mol %, more preferably to more than 2.5 mol %.

Further, the present invention provides a method for decreasing the cold flow without increasing the elasticity at high shear rates of halogenated polymers containing repeating units derived from at least one C₄ to C₇ isomonoolefin monomer, at least one C₄ to C₁₄ multiolefin monomer and optionally further monomers by increasing the amount of repeating units derived from said multiolefin monomer(s) in the polymer chain preferably to more than 2.0 mol %, more preferably to more than 2.5 mol %.

### BRIEF DESCRIPTION OF THE DRAWINGS

FIG. 1 illustrates Raw Polymer (RP) Mooney vs. Mooney Relaxation of Examples 1-6 and 7-12.

FIG. 2 illustrates the stress relaxation properties of compounds made using the high IP (Examples 1-6) and low IP (Examples 7-12) content samples.

FIG. 3 illustrates the relaxed die swell of compounds made using the high IP (Examples 1-6) and low IP content samples (Examples 7-12).

### DETAILED DESCRIPTION OF THE INVENTION

The present invention relates to butyl rubber polymers. The terms “butyl rubber”, “butyl polymer” and “butyl rubber polymer” are used throughout this specification interchangeably. While the prior art in using butyl rubber refers to polymers prepared by reacting a monomer mixture containing a C₄ to C₇ isomonoolefin monomer and a C₄ to C₁₄ multiolefin monomer, the present invention relates to polymers containing repeating units derived from at least one C₄ to C₇ isomonoolefin monomer, at least one C₄ to C₁₄ multiolefin monomer and optionally one or more further copolymerizable monomers.

The present invention is not restricted to any particular C₄ to C₇ isomonoolefin monomer. Preferred C₄ to C₇ monoolefins include isobutylene, 2-methyl-1-butene, 3-methyl-1-butene, 2-methyl-2-butene, 4-methyl-1-pentene and mixtures thereof. The more preferred C₄ to C₇ isomonoolefin monomer is isobutylene.

Furthermore, the present invention is not restricted to any particular C₄ to C₁₄ multiolefin. However conjugated or non-conjugated C₄ to C₁₄ diolefins are preferably useful. Preferred C₄ to C₁₄ multiolefin monomers include isoprene, butadiene, 2-methylbutadiene, 2,4-dimethylbutadiene, piperyline, 3-methyl-1,3-pentadiene, 2,4-hexadiene, 2-neopentylbutadiene, 2-methly-1,5-hexadiene, 2,5-dimethly-2,4-hexadiene, 2-methyl-1,4-pentadiene, 2-methyl-1,6-heptadiene, cyclopenta-diene, methylcyclopentadiene, cyclohexadiene, 1-vinyl-cyclohexadiene or mixtures thereof. The more preferred C₄ to C₁₄ multiolefin monomer is isoprene.

Preferably, the monomer mixture to be polymerized contains in the range of from 70% to 98% by weight of at least one C₄ to C₇ isomonoolefin monomer, in the range of from 2.0% to 30% by weight of at least one C₄ to C₁₄ multiolefin monomer. More preferably, the monomer mixture contains in the range of from 85% to 98.5% by weight of a C₄ to C₇ isomonoolefin monomer, in the range of from 2.5% to 15% by weight of a C₄ to C₁₄ multiolefin monomer. Even more preferably, the monomer mixture contains in the range of from 85% to 97% by weight of a C₄ to C₇ isomonoolefin monomer, in the range of from 3.0% to 15% by weight of a C₄ to C₁₄ multiolefin monomer. Most preferably, the monomer mixture contains in the range of from 85% to 93% by weight of a C₄ to C₇ isomonoolefin monomer, in the range of from 7.0% to 15% by weight of a C₄ to C₁₄ multiolefin monomer.

The monomer mixture may contain minor amounts of one or more additional polymerizable co-monomers. For example, the monomer mixture may contain a small amount of a styrenic monomer like p-methylstyrene, styrene, α-methylstyrene, p-chlorostyrene, p-methoxystyrene, indene (including indene derivatives) and mixtures thereof. If present, it is preferred to use the styrenic monomer in an amount of up to 5.0% by weight of the monomer mixture. The values of the C₄ to C₇ isomonoolefin monomer(s) will have to be decreased accordingly to result again in a total of 100% by weight.

The use of even other monomers in the monomer mixture is possible, provided, of course, that they are copolymerizable with the other monomers in the monomer mixture.

The present invention is not restricted to a special process for preparing/polymerizing the monomer mixture. This type of polymerization is well known to the skilled in the art and usually includes contacting the reaction mixture described above with a catalyst system. Preferably, the polymerization is conducted at a temperature conventional in the production of butyl polymers —e.g., in the range of from −100° C. to +50° C. The polymer may be produced by polymerization in solution or by a slurry polymerization method. Polymerization is preferably conducted in suspension (the slurry method)—see, for example, Ullmann's Encyclopedia of Industrial Chemistry (Fifth, Completely Revised Edition, Volume A23; Editors Elvers et al., 290-292).

As an example, in one embodiment the polymerization is conducted in the presence of an inert aliphatic hydrocarbon diluent (such as n-hexane) and a catalyst mixture containing a major amount (in the range of from 80 to 99 mole percent) of a dialkylaluminum halide (for example diethylaluminum chloride), a minor amount (in the range of from 1 to 20 mole percent) of a monoalkylaluminum dihalide (for example isobutylaluminum dichloride), and a minor amount (in the range of from 0.01 to 10 ppm) of at least one of a member selected from the group comprising water, aluminoxane (for example methylaluminoxane) and mixtures thereof. Of course, other catalyst systems conventionally used to produce butyl polymers can be used to produce a butyl polymer which is useful herein—see, for example, “Cationic Polymerization of Olefins: A Critical Inventory” by Joseph P. Kennedy (John Wiley & Sons, Inc. © 1975, 10-12).

Polymerization may be performed both continuously and discontinuously. In the case of discontinuous operation, the process may, for example, be performed as follows: The reactor, precooled to the reaction temperature, is charged with solvent or diluent and the monomers. The initiator is then pumped in the form of a dilute solution in such a manner that the heat of polymerization may be dissipated without problem. The course of the reaction may be monitored by means of the evolution of heat.

The preferred polymerization method is disclosed in EP-A1-818 476.

The polymerization is preferably performed in the presence of an organic nitro compound and a catalyst/initiator selected from the group consisting of vanadium compounds, zirconium halogenid, hafnium halogenids, mixtures of two or three thereof, and mixtures of one, two or three thereof with AlCl₃, and from AlCl₃ derivable catalyst systems, diethylaluminum chloride, ethylaluminum chloride, titanium tetrachloride, stannous tetrachloride, boron trifluoride, boron trichloride, or methylalumoxane. The polymerization is preferably performed in a suitable solvent, such as chloroalkanes, in such a manner that in case of vanadium catalysis the catalyst only comes into contact with the nitroorganic compound in the presence of the monomer in case of zirconium/hafnium catalysis the catalyst only comes into contact with the nitroorganic compound in the absence of the monomer. The nitro compounds used in this process are widely known and generally available. The nitro compounds preferably used are disclosed in co-pending DE 100 42 118.0 which are defined by the general formula (I)

R—NO₂ (I)

wherein R is selected from the group H, C₁-C₁₈ alkyl, C₃-C₁₈ cycloalkyl or C₆-C₂₄ cycloaryl.

C₁-C₁₈ alkyl is taken to mean any linear or branched alkyl residues with 1 to 18 C atoms known to the person skilled in the art, such as methyl, ethyl, n-propyl, i-propyl, n-butyl, i-butyl, t-butyl, n-pentyl, i-pentyl, neopentyl, hexyl and further homologues, which may themselves in turn be substituted, such as benzyl. Substituents, which may be considered in this connection, include alkyl or alkoxy and cycloalkyl or aryl, such benzoyl, trimethylphenyl, ethylphenyl. Methyl, ethyl and benzyl are preferred.

C₆-C₂₄ aryl means any mono- or polycyclic aryl residues with 6 to 24 C atoms known to the person skilled in the art, such as phenyl, naphthyl, anthracenyl, phenanthracenyl and fluorenyl, which may themselves in turn be substituted. Substituents which may in particular be considered in this connection are alkyl or alkoxyl, and cycloalkyl or aryl, such as toloyl and methylfluorenyl. Phenyl is preferred.

C₃-C₁₈ cycloalkyl means any mono- or polycyclic cycloalkyl residues with 3 to 18 C atoms, such as cyclopropyl, cyclobutyl, cyclopentyl, cyclohexyl, cycloheptyl, cyclooctyl and further homologues, which may themselves, in turn, be substituted. Substituents which may be considered in this connection include alkyl or alkoxy, and cycloalkyl or aryl, such as benzoyl, trimethylphenyl, ethylphenyl. Cyclohexyl and cyclopentyl are preferred.

The concentration of the organic nitro compound in the reaction medium is preferably in the range from 1 to 15000 ppm, more preferably in the range from 5 to 500 ppm. The ratio of nitro compound to vanadium is preferably of the order of 1000:1, more preferably of the order of 100:1 and most preferably in the range from 10:1 to 1:1. The ratio of nitro compound to zirconium/hafnium is preferably of the order of 100:1, more preferably of the order of 25:1 and most preferably in the range from 14:1 to 1:1.

The monomers are generally polymerized cationically at temperatures in the range from −120° C. to +20° C., preferably in the range from −100° C. to −20° C., and pressures in the range from 0.1 to 4 bar.

Inert solvents or diluents known to the person skilled in the art for butyl polymerization may be considered as the solvents or diluents (reaction medium). These include alkanes, chloroalkanes, cycloalkanes or aromatics, which are frequently also mono- or polysubstituted with halogens. Hexane/chloroalkane mixtures, methyl chloride, dichloromethane or the mixtures thereof are preferred. Chloroalkanes are more preferably used in the process according to the present invention.

As stated hereinabove, the polymer of the invention may be halogenated. Preferably, the halogenated butyl polymer is brominated or chlorinated. Preferably, the amount of halogen is in the range of from 0.1 to 8 wt. %, more preferably from 0.5 to 4 wt. %, most preferably from 1.0 to 3.0 wt. %.

The halogenated butyl polymer may be produced by halogenating a previously-produced butyl polymer derived from the monomer mixture described hereinabove.

Halogenated isoolefin rubber, especially butyl rubber, may be prepared using relatively facile ionic reactions by contacting the polymer, preferably dissolved in organic solvent, with a halogen source, e.g., molecular bromine or chlorine, and heating the mixture to a temperature ranging from 20° C. to 90° C. for a period of time sufficient for the addition of free halogen in the reaction mixture onto the polymer backbone.

Another continuous method is the following: Cold butyl rubber slurry in chloroalkan (preferably methyl chloride) from the polymerization reactor is passed to an agitated solution in drum containing liquid hexane. Hot hexane vapors are introduced to flash overhead the alkyl chloride diluent and unreacted monomers. Dissolution of the fine slurry particles occurs rapidly. The resulting solution in stripped to remove traces of alkyl chloride and monomers, and brought to the desired concentration for halogenation by flash concentration. Hexane recovered from the Flash concentration step is condensed and returned to the solution drum. In the halogenation process butyl rubber in solution is contacted with chlorine or bromine in a series of high-intensity mixing stages. Hydrochloric or hydrobromic acid is generated during the halogenation step and must be neutralized. For a detailed description of the halogenation process see U.S. Pat. Nos. 3,029,191 and 2,940,960, as well as U.S. Pat. No. 3,099,644 which describes a continuous chlorination process and EP-A1-0 803 518 or EP-A1-0 709 401.

Another process suitable in the present invention is disclosed in EP-A1-0 803 518 in which an improved process for the bromination of a C₄-C₆ isoolefin-C₄-C₆ conjugated diolefin polymer which includes preparing a solution of said polymer in a solvent, adding to said solution bromine and reacting said bromine with said polymer at a temperature of from 10° C. to 60° C. and separating the brominated isoolefin-conjugated diolefin polymer, the amount of bromine being from 0.30 to 1.0 moles per mole of conjugated diolefin in said polymer, characterized in that said solvent contains an inert halogen-containing hydrocarbon, said halogen-containing hydrocarbon comprising a C₂ to C₆ paraffinic hydrocarbon or a halogenated aromatic hydrocarbon and that the solvent further contains up to 20 volume per cent of water or up to 20 volume per cent of an aqueous solution of an oxidising agent that is soluble in water and suitable to oxidize the hydrogen bromide to bromine in the process substantially without oxidizing the polymeric chain.

Those skilled in the art will be aware of many more suitable halogenation processes but a further enumeration of suitable halogenation processes is not deemed helpful for further promoting the understanding of the present invention.

The butyl rubbers may be used for the production of vulcanized rubber products. For example, useful vulcanizates may be produced by mixing the butyl rubber with carbon black, silica and/or other known ingredients (e.g., other fillers, other additives, etc.) and crosslinking the mixture with a conventional curing agent in a conventional manner. Vulcanizates of halogenated butyl rubber may be similarly prepared.

Embodiments of the present invention will be illustrated with reference to the following Examples, which should not be use to construe or limit the scope of the present invention.

### EXAMPLES

Materials

Methyl chloride (MeCl) and isobutylene (IB) were used as received from Matheson Gas Products. The MeCl had a purity level of 99.9% and its moisture content was less than 20 ppm. The IB purity level was 99% with a moisture content less than 20 ppm. 2,4,4-Trimethyl-1-pentene (TMP-1, Aldrich 99%) was used as received. Isoprene (IP, Aldrich 99%) was filtered using an inhibitor remover, disposable column to remove the inhibitor, p-tert-butylcatechol.

Procedure

The experiments were conducted in the MBraun Labmaster Dry box under an inert nitrogen environment, ensuring the moisture level was less than 10 vpm and the oxygen content lower than 50 vpm.

Test Methods

Raw polymer Mooney and Mooney relaxation measurements were conducted at 125° C. using the MV 2000 rotational viscometer manufactured by Monsanto. The run time was set at eight minutes with a one-minute preheat followed by an eight minute relaxation time. Molecular weight and molecular weight distribution was measured using Waters SEC equipped with six ultrastyragel columns (10⁶, 10⁵, 10⁴, 10³, 500, 100), Waters refractive index detector and miniDAWN Laser Light Scattering detector manufactured by Wyatt Technology.

Dynamic properties of all the samples were determined by a Rubber Processability Analyzer (RPA 2000) made by Alpha Technology. Frequency sweeps were carried out in the angular frequency range of 0.05- 209 rad/s at 125° C. using 0.72 degree arc. Stress relaxation was measured at 125° C. using 100% strain and 240 second relaxation time. Initial slope was determined from the logarithmic plot of torque versus time values in the 0.01-1.0s range.

### Examples 1-6

A series of batch experiments were conducted using 1.27 M of isobutylene, 0.06M of isoprene and 900 mL of methyl chloride in a 2.0L reaction flask equipped with a high-speed marine-type impeller. Varying amounts of TMP-1 were added, as specified in Table 1 in order to alter the molecular weight of the samples. The reaction mixture was cooled to −93° C. and the polymerization was initiated by the addition of a dilute solution of aluminum chloride in MeCl. The reaction time was 5 min. Polymerization was terminated by the addition of 10 mL of ethanol containing a small amount of NaOH. The polymer product was dissolved in hexane, stabilized with 0.05 phr of Irganox® 1076 and steam coagulated. The product was then dried on a hot mill at 140° C. and characterized. The results are given in Table 1.

TABLE 1
Experimental Conditions and Results

| Example | 1 | 2 | 3 | 4 | 5 | 6 |
|---|---|---|---|---|---|---|
| TMP (mol/L) | 0 | 3.14 × 10⁻⁴ | 3.14 × 10⁻⁴ | 6.27 × 10⁻⁴ | 9.41 × 10⁻⁴ | 1.25 × 10⁻³ |
| AlCl₃ (mol/L) | 3.57 × 10⁻⁴ | 3.57 × 10⁻⁴ | 3.57 × 10⁻⁴ | 3.57 × 10⁻⁴ | 3.57 × 10⁻⁴ | 3.57 × 10⁻⁴ |
| Catalyst Efficiency | 1000 | 1100 | 900 | 1230 | 920 | 1310 |
| (g. polym./g. cat.) | | | | | | |
| Conversion | 65.0 | 62.7 | 68.7 | 70.1 | 74.3 | 74.6 |
| wt % | | | | | | |
| Mooney | 35.4 | 26.1 | 25.5 | 20.6 | 21.6 | 13.6 |
| (1 + 8 @ 125° C.) | | | | | | |
| Mooney Relaxation | 416.9 | 112.4 | 196.5 | 112.4 | 125.3 | 43.9 |
| (Area under curve) | | | | | | |
| IP (mol %) | 2.78 | 2.51 | 2.75 | 2.68 | 2.77 | 2.91 |

### Examples 7-12

For comparative purposes a series of batch experiments using standard isoprene concentration was also carried out. The same experimental conditions were applied as outlined in examples 1-6. The recipe for this set of experiments was 1.27M of isobutylene, 0.03M of isoprene and 900 mL of methyl chloride in a 2.0L reaction flask. The same chain transfer agent 2,4,4-trimetyl- 1-pentene was utilized to alter the molecular weight. Details of the set-up and the results are given in Table 2.

TABLE 2
Experimental Conditions and Results

| Example | 7 | 8 | 9 | 10 | 11 | 12 |
|---|---|---|---|---|---|---|
| TMP (mol/L) | 0 | 3.14 × 10⁻⁴ | 3.14 × 10⁻⁴ | 6.29 × 10⁻⁴ | 1.26 × 10⁻³ | 1.87 × 10⁻³ |
| AlCl₃ (mol/L) | 3.17 × 10⁻⁴ | 3.10 × 10⁻⁴ | 5.17 × 10⁻⁴ | 3.17 × 10⁻⁴ | 3.17 × 10⁻⁴ | 3.10 × 10⁻⁴ |
| Catalyst Efficiency | 1350 | 1280 | 920 | 1360 | 1350 | 1430 |
| (g. polym./g. cat.) | | | | | | |
| Conversion | 79.0 | 73.0 | 86.8 | 79.2 | 78.9 | 81.4 |
| wt % | | | | | | |
| Mooney | 48.8 | 46.2 | 32.8 | 35.8 | 32.4 | 22.9 |
| (1 + 8 @ 125° C.) | | | | | | |
| Mooney Relaxation | N.A. | 259 | 133.4 | 117 | 74 | 22 |
| (Area under curve) | | | | | | |
| IP (mol %) | 1.43 | 1.38 | 1.43 | 1.43 | 1.42 | 1.51 |

The tables indicate that as the amount of TMP increases the Mooney decreased, thereby proving that Mooney can be controlled by the amount of TMP introduced into the reaction.

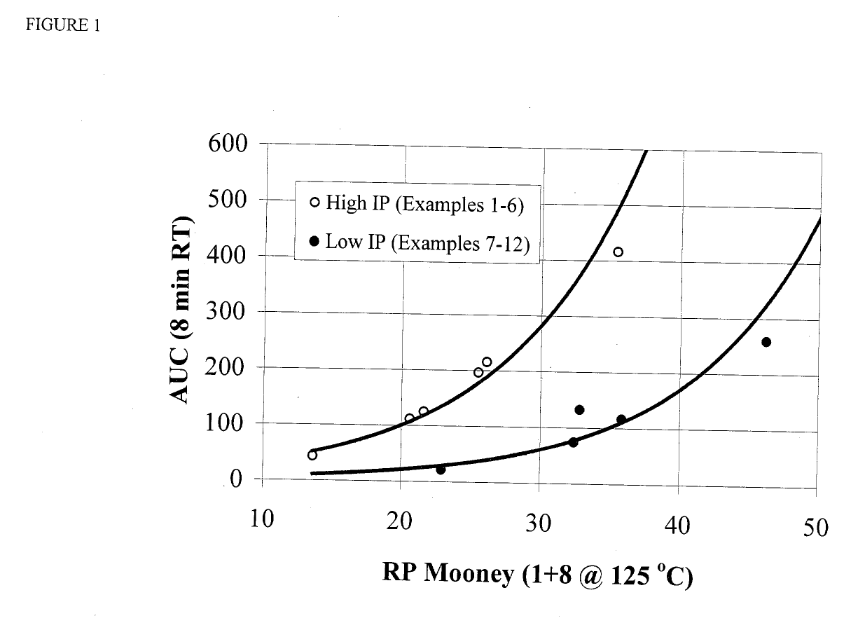

In both experimental cases, the Mooney relaxation results show that with decreasing Mooney the area under the relaxation curve also decreases, indicating an increasing ability of the sample to flow under stress. FIG. 1 states the Raw Polymer (RP) Mooney vs. Mooney Relaxation of Examples 1-6 and 7-12. The Examples 1-6 according to the invention flow significantly less under stress than the comparative samples (Examples 7-12).

For stress relaxation and die swell measurements the samples of Examples 1-6 and Examples 7-12 were compounded with 60 phr carbon black (N660).

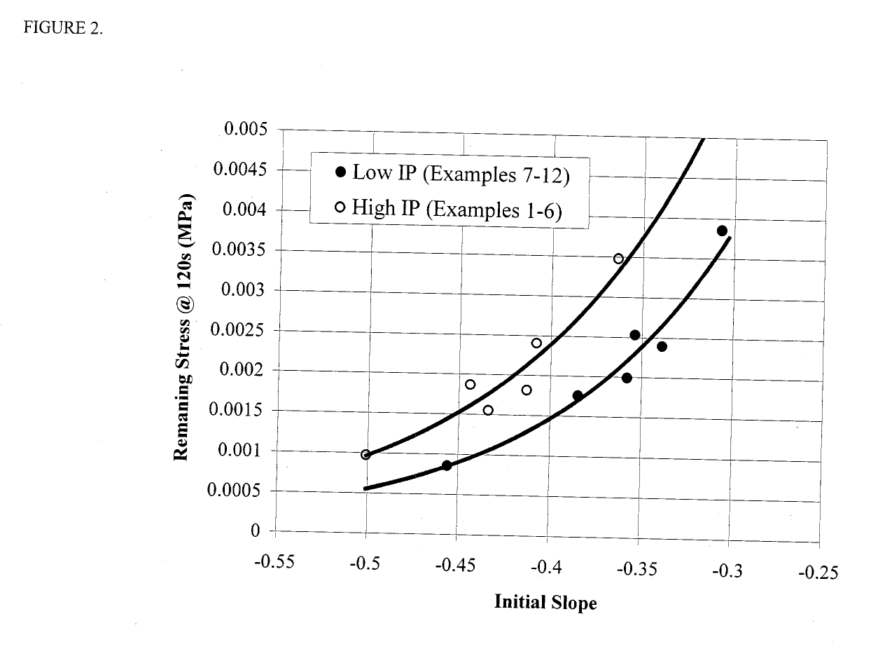

During the stress relaxation test a sudden strain is applied to the sample by moving the lower die by 7 degree at the highest speed of the instrument. The lower die then kept at this position and the decay of torque is measured at the upper die as a function of time. The initial slope is a measure of the rate of relaxation right after the strain was applied to the sample. Numerically it is the slope of the relaxation curve plotted in log stress—log time format in the 0.01—1s time period. This slope reflects to the ability of the sample to relax after it was exposed to a high shear rate deformation for a short period of time. With time the stress decays. The remaining stress at longer time is characteristic to the sample ability to resist flow under low shear rates. Higher remaining stress at longer times is an indication that the sample is more likely to resist cold flow. A polymer with a good combination of processability characteristics should have a steep initial slope, i.e., fast relaxation at high shear rates and a high remaining stress at longer times, i.e, a good resistance to cold flow. Cold flow can be reduced by increasing the molecular weight of the polymer. However, increasing molecular weight will also result in a slower relaxation at high shear rate. This is illustrated by FIG. 2, which is a plot of the remaining stress measured at 120s as a function of the initial slope. The points corresponding to the same isoprene content samples show a concurrent increase of remaining stress and initial slope with increasing molecular weight or Mooney. The important difference between samples 1-6 and 6-12 (comparative) is that they fall on a different curve. At the same initial slope the samples according to the invention display a higher remaining stress. This is an indication that the cold flow resistance can be increased without increasing the elasticity of the sample at high shear rates, e.g., without increasing the die swell at the same time.

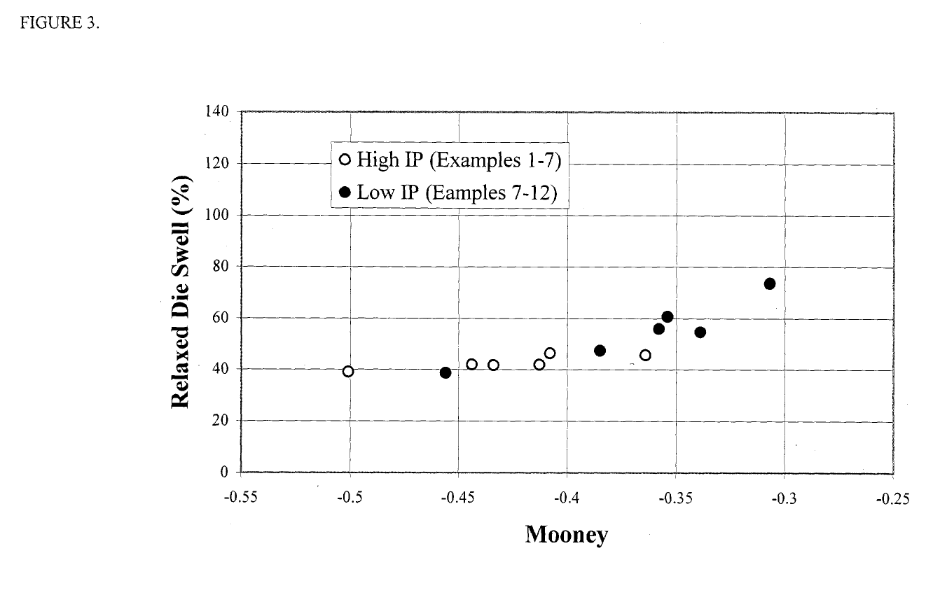

The ability of the initial slope to describe die swell properties is illustrated by FIG. 3. Die swell measurements were carried using a capillary viscometer (Monsanto Porcessability Tester). Measurements were done at 125° C. using 1000 1/s shear rate and a die with L/D=5 configuration. According to FIG. 3., points of Examples 1-6 and Examples 7-12 follow the same trend proving that the initial slope of the stress relaxation curve can describe the die swell of the select samples.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for reducing the cold flow of a polymer having repeating units derived from at least one C₄ to C₇ isomonoolefin monomer, at least one C₄ to C₁₄ multiolefin monomer and optionally further monomers comprising the step of admixing a C₄ to C₇ isomonoolefin monomer and at least one C₄ to C₁₄ multiolefin monomer and optionally further monomers in the presence of a catalyst system and optionally an organic nitro compound, wherein the amount of repeating units derived from at least one multiolefin monomer in the polymer is more than 2.0 mol %.

2. A method according to claim 1, wherein in the amount of repeating units derived from the multiolefin monomer(s) in the polymer more than 2.5 mol %.

3. A method according to claim 1, wherein the polymer is halogenated.

4. The method according to claim 1 wherein the C₄ to C₇ monoolefin is selected from the group consisting of isobutylene, 2-methyl-1-butene, 3-methyl-i -butene, 2-methyl-2-butene, 4-methyl-i -pentene and mixtures thereof.

5. The method according to claim 1, wherein the C₄ to C₁₄ multiolefin monomer(s) is selected from the group consisting of isoprene, butadiene, 2-methylbutadiene, 2,4-dimethylbutadiene, piperyline, 3-methyl-1,3-pentadiene, 2,4-hexadiene, 2-neopentylbutadiene, 2-methly-1,5-hexadiene, 2,5-dimethly-2,4-hexadiene, 2-methyl-1,4-pentadiene, 2-methyl-1,6-heptadiene, cyclopenta-diene, methylcyclopentadiene, cyclohexadiene, 1-vinyl-cyclohexadiene or mixtures thereof.

6. The method according to claim 5, wherein the C₄ to C₁₄ multiolefin monomer(s) is isoprene.

7. The method according to claim 1, wherein the catalyst comprises a dialkylaluminum halide, a monoalkylaluminum dihalide and at least one of a member selected from the group consisting of water, aluminoxane and mixtures thereof.

8. The method according to claim 1, wherein the optional further monomer is selected from the group consisting of p-methylstyrene, styrene, a-methylstyrene, p-chlorostyrene, p-methoxystyrene, indene, indene derivatives and mixtures thereof.
